(19) United States
(12) Patent Application Publication
(10) Pub. No.: US 2011/0023022 A1
(43) Pub. Date: Jan. 27, 2011

(54) METHOD FOR APPLICATION AUTHORING EMPLOYING AN APPLICATION TEMPLATE STORED IN A DATABASE

(75) Inventors: Jeffrey Todd Harper, Tualatin, OR (US); Aslam Khader, Beaverton, OR (US); Fumiko Salvat Kutch, Beaverton, OR (US); Alice VonWald Sufka, Portland, OR (US); Mark-Andrew Ray Tait, Beaverton, OR (US); Halstead Winship York, Portland, OR (US)

Correspondence Address: MARGER JOHNSON & MCCOLLOM, P.C., 210 SW MORRISON STREET, SUITE 400, PORTLAND, OR, 97204, US

(73) Assignee: Ensequence, Inc., Portland, OR (US)

(21) Appl. No.: 12/509,397

(22) Filed: Jul. 24, 2009

(51) Int. Cl. G06F 9/44; G06F 17/30

(52) U.S. Cl. 717/170; 707/E17.055

(57) ABSTRACT

A computer system is used to create an application. Application source code or an executable application is converted into an in-memory representation. The in-memory representation is stored in a database. Attributes of the database representation are selected for modification, and constraints are assigned to the modifications. Modifications and constraints are stored in the database to create an application template. A copy of the application template is made in the database, and modifications are performed on the copy in the database. The modified copy of the application template is retrieved from the database and used to create an executable application.

### FIELD OF THE INVENTION

This invention relates generally to modification of an application program to produce an upgraded version of the program. More specifically, the invention describes the use of a database to store and manipulate an application template to create an upgraded version of the application defined by the template.

### BACKGROUND OF THE INVENTION

The development of complex software applications has become a team effort. The days of a solo engineer working to craft all of the source code for an application have given way to a highly cooperative environment in which multiple developers contribute to an end product. Nowhere is this collaborate style more evident than in the development of interactive television (iTV) applications, which combine stringent requirements and often arcane engineering expertise with the desire for highly attractive and compelling user interface appearance and behavior.

The development of a user interface application consists of generating or modifying a body of source code that defines the appearance and behavior of the application, and selecting or creating resources such as textual content, images, video sequences, audio sequences, and other auditory or graphical material that are displayed in conjunction with the execution of the application. For collaborative development projects, modern software engineering practice encourages the use of software configuration management (SCM) systems that can be used to store source code files, textual content, binary image content, and other artifacts associated with an application. An SCM system can track modifications to source code to allow multiple versions of a project to exist in parallel, can manage access to the individual artifacts of an application, and can allow collaboration among team members, even when located at multiple worksites. SCM systems are intended for use with human-readable files, affording efficient storage of differences between successive revisions to a file and allowing regeneration of previous versions on demand. Some SCM systems accommodate binary file content, by storing the entirety of each successive version of a binary component of a project. In general, SCM systems treat the artifacts of a project at a coarse-grained level, the level of individual files or resources.

Database (DB) technology provides the capability for managing a body of data at a very fine-grained level. Any specific datum can be modified, and the modification can be managed and tracked, using conventional DB methodology. DB systems allow for control over who can access or perform modifications to data, and manage concurrency among multiple users of the database to avoid data collisions and reconcile access conflicts. Database systems can also provide efficiencies of storage by reducing the need to store duplicate copies of large or complex entities. Moreover, modern object-based databases allow the storage and manipulation of collections of data structures as objects, rather than being limited to simply storing numbers or textual content. Database systems also provide for scalability, allowing for easy expansion to larger projects, larger numbers of projects, and larger numbers of users accessing project data; provide for data security and fault tolerance, to protect data integrity in the face of hardware or software failures; and provide for distributed support of database functionality, allowing simultaneous access to a database from multiple dispersed locations.

What is required is a method and system for application authoring and application versioning that combines the features of a source configuration management system with the features and functionality of modern object-based databases.

### SUMMARY OF THE INVENTION

The current invention provides a computer system and method for authoring applications based on an application template, characterized by creating an application template, for example by creating an in-memory object representation of an original application, storing the object representation in an object database, and converting the object representation into an application template, for example by selecting at least one attribute of the object representation that is suitable for modification, creating one or more metadata items that specify an attribute suitable for modification and specify at least one requirement for the modification of the attribute, aggregating the metadata items, associating the aggregated metadata with the object representation, and storing the metadata with the object representation in the object database; making a copy of the application template in the database; modifying the copy, for example by selecting at least one metadata item associated with the copy of the object representation and modifying at least one attribute of the object representation specified in the metadata item in accordance with all requirements for the modification of the attribute; and generating an executable application from the modified template, for example by extracting the modified copy of the object representation to create a modified in-memory object representation, and generating an executable version of the modified application from the in-memory modified object representation.

In a further embodiment of the inventive system and method, the generation of an executable version is performed by generating a set of at least one human-readable source code file from the in-memory modified object representation and compiling the source code to produce an executable application.

In a still further embodiment of the inventive system and method, the generation of an executable version is performed directly from the in-memory modified object representation.

In a further embodiment of the inventive system and method, the in-memory object representation is created by parsing the source code for the original application.

In a still further embodiment of the inventive system and method, the in-memory object representation is created by decompiling the executable version of the original application

In a still further embodiment of the inventive system and method, the database operations are performed through a web services interface.

In a still further embodiment of the inventive system and method, the attribute to be modified is one of the position, size, shape, or color of a region of color displayed by the application.

In a still further embodiment of the inventive system and method, the attribute to be modified is one of the position, background color, font face, font size, font weight, text color, alignment, or textual content of an area of text displayed by the application.

In a still further embodiment of the inventive system and method, the attribute to be modified is one of the position, size, or image content of an image displayed by the application.

In a still further embodiment of the inventive system and method, the requirement for a modification is that the modified value is one of a list of valid values.

In a still further embodiment of the inventive system and method, the requirement for a modification is that the modified value falls within a bounded or half-bounded range of values.

In a still further embodiment of the inventive system and method, the requirement for a modification is that the modified value matches a regular expression.

### BRIEF DESCRIPTION OF THE DRAWINGS

The preferred and alternative embodiments of the present invention are described in detail below with reference to the following drawings.

FIG. 1 depicts the components of an application authoring system utilizing the present invention.

FIG. 2 depicts a display image resulting from a simple application using the invention.

FIG. 3 depicts a portion of the source code for the simple application of FIG. 2.

FIG. 4 depicts a schematic view of a database representation of the application of FIG. 3.

FIG. 5 depicts a portion of exemplary database structures representing a simple application, such as in FIG. 2.

FIG. 6 depicts a portion of the source code for an exemplary style definition of an application such as FIG. 2.

FIG. 7 depicts a portion of exemplary database structures representing the exemplary style definition of FIG. 6.

FIG. 8 depicts an example of source code for a data table of FIG. 7.

FIG. 9 depicts a portion of exemplary database structures representing a data table as in FIG. 8.

FIG. 10 depicts a flowchart of an exemplary method of creating an application template according to methods of the invention.

FIG. 11 depicts a software layer model per the invention.

FIG. 12 depicts a flowchart of an exemplary method of editing an application template according to the invention.

### DETAILED DESCRIPTION OF THE INVENTION

By way of overview, embodiments of the present invention provide a method for authoring a modified version of an application.

As used herein, the term “application” is intended to refer to a body of digital information comprising code and data that when processed on a suitable computing platform yields appearance and behavior as intended by the creator of the application. An application may be encoded using native CPU instructions, interpreted byte codes, declarative data structures, or any combination of such encodings. An application may respond to external events by appropriate modification of appearance and behavior, as specified by the code and data comprising the application.

As used herein, the term “metadata” is intended to refer to human-readable or binary content which is not part of the source code or executable content of an application, but which refers to attributes of the source code or executable content of the application, or to modifications that may be made to such attributes.

As used herein, the term “object” is intended to refer to a software entity defined by a body of software code that declares the member properties and functions of the entity. Objects form the basis of object-oriented software languages. An object may be considered to be a collection of data upon which operations can be performed, the object encapsulating the details of how the data are stored and manipulated.

As used herein, the term “object instance” is intended to refer to a collection of data in a structured format that describe a single instantiation of a software object class defined by member properties and functions. The data of an object instance correspond to the values of the various member properties of the class. The data of an object instance may include executable code in source or executable format corresponding to a property or properties of the instance. The complete representation of an object instance may also require reference to the values of properties shared by all instances of the software object class. In common with conventional usage, the term “object” may refer herein to a class of entities with a shared specification or to a specific instance of the class, depending on the context of the usage. When necessary to disambiguate the latter meaning, the term “object instance” is used in distinction to the term “object”.

As used herein, the term “object representation” is intended to refer to an object instance or a hierarchy of object instances, the cumulated properties of which and relationships among which form the structure and define the functionality of an application. Each of the object instances in an object representation has associated properties and functions defined by the body of software code that declares the member properties and functions of the corresponding object class.

As used herein, the term “template” is intended to refer to a body of data stored in an object database representing an object-based representation of an application and associated metadata. The associated metadata define allowable modifications to the object-based representation. The object-based representation for a template can be modified in accordance with metadata associated with the object-based representation. The modified object-based representation can be extracted from the database and used to generate an application. The phrase “application template” as used herein is synonymous with the term “template”.

As used herein, the phrase “generate an application” is intended to refer to the process of converting an in-memory object-based representation of an application into a machine-readable format suitable for ingestion and execution by a suitable computing platform.

As used herein, the term “resource” is intended to refer to a body of binary data, exclusive of application source code, that is used during the execution of an application to control the appearance or behavior of an application.

The various aspects of the claimed subject matter are now described with reference to the annexed drawings. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. Additionally it should be appreciated that a carrier wave can be employed to carry computer-readable electronic data such as those used in transmitting and receiving electronic mail or in accessing a network such as the Internet or a local area network. Of course, those skilled in the art will recognize many modifications may be made to this configuration without departing from the scope or spirit of the claimed subject matter.

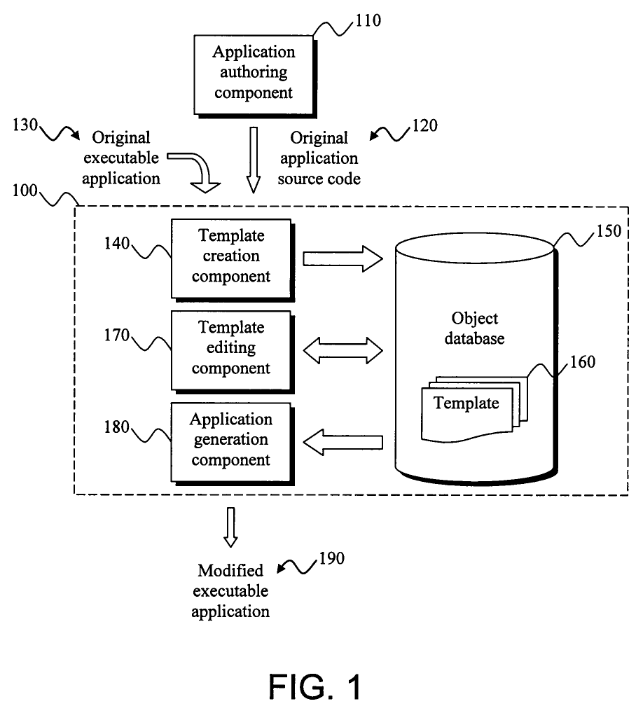

FIG. 1 shows an exemplary implementation of an application authoring system utilizing the current invention. An exemplary template authoring system 100 receives a representation of an original application from an external source. The original application may be encoded using an external application authoring component 110, which generates a body of application source code 120 representing the application. An example of a suitable application authoring component 110 is the Create ETV-BIF™ product developed by Ensequence, Inc. of Portland, Oreg. A further example of an application authoring component 110 is the TVWorks XML Development Kit™ developed by TVWorks, LLC, of Mill Valley, Calif. Alternatively, template authoring system 100 receives an executable application 130 from an external source, the application comprising one or more binary files, each in a predefined format.

The representation of the original application is processed by a template creation component 140. A user of template creation component 140 creates an in-memory object representation of the original application, for example by using component 140 to parse application source code 120 or by analyzing or otherwise reverse-compiling application executable 130. A user of template creation component 140 then stores the in-memory object representation into object database 150 in the form of database structures that reflect the contents of the in-memory object representation of the application. A user of template creation component 140 then examines the various elements of the in-memory representation and selects one or more attributes that are desired to be subject to modification when creating a new version of the original application. A user may also associate one or more restrictions on the choices that may be made when modifying an attribute. All such modifications and restrictions are encoded as metadata to be associated with the application representation to form an application template. Individual modifications might be further labeled as required or optional. When the desired set of modifications and restrictions have been selected and specified, a user of template creation component 140 then stores the associated metadata into object database 150 and associates the metadata with the database representation of the application to create an application template 160. Communication between template creation component 140 and object database 150 may be through any conventional means, such as Software Query Language (SQL) or other suitable database transaction interface protocol.

Once an application template 160 has been created in the object database 150, template editing component 170 provides an interface to allow authoring of a modified application based on the application template. As described above for the template creation component, communication between template editing component 170 and object database 150 may be through any conventional means. A user of template editing component 170 can make a copy of an application template 160, query to determine the modifiable attributes of the template, and assign values to one or more modifiable attributes, storing the new values into the copy of the application template. Following conventional database access and manipulation practice, the right to perform particular operations in the database may be restricted to particular individuals. For example, for a given application template 160, a single person may have the right to make a copy of the template, that right belonging to a ‘role’ designated as the ‘owner’ of the template. The owner of the template may have the right to assign ownership to a second party, and may have the right to associate particular roles with the various possible modifications that can be made to the copy of the template. For example, one role might be granted the right to change the textual content of particular object instances (a ‘text editor’ role), while another role might be granted the right to change the image content of other particular object instances (a ‘graphical editor’) role. Yet another role might be granted the right to review all modifications (a ‘reviewer’ role). The definition of access and manipulation roles to objects in a database, and the assignment of individuals to particular roles, are conventional features of database systems and database manipulation known in the prior art. Inasmuch as multiple individuals might be assigned to multiple roles granting access to a particular application template and its modifications, the task of authoring a modified application might involve multiple users interacting with the object database 150 through template editing component 170. The final step of modifying the copy of application template 160 might require the review of all possible modifications to ensure that all required modifications have been performed and that the supplied values of all modifications meet a set of external criteria not encoded within the template, for example, that stylistic guidelines have been followed when modifying the application and that no spelling or grammatical errors are found in textual content specified during the template editing process.

Once all modifications to the copy of application template 160 have been made and optionally reviewed, application generation component 180 is used to generate the final executable application. A user of application generation component 180 retrieves all the data in the modified copy of application template 160. This retrieval is achieved using a standard database interface protocol. The retrieved data are used to create an in-memory representation of the modified application, similar in structure but different in at least one detail from the in-memory representation originally created for the application in application template creation component 140. The in-memory representation of the modified application is used to generate an executable version 190 of the application. This generation can proceed through the generation of one or more source code files representing the content of the in-memory representation, followed by compilation of the source code files by an external application to generation an executable version of the application. Alternatively, the in-memory form could be used to directly generate the executable module or modules representing the executable version of the application.

The steps involved in creating an application template, copying and modifying the template, and generating an executable version of the modified application are now described in further detail. By way of illustration, the following description describes an exemplary implementation of the inventive method, in which the application source code is written using the TVScript-BIF language as employed in the Create ETV-BIF™ authoring environment marketed by Ensequence, Inc., Portland, Oreg.

Briefly, TVScript-BIF is an object-oriented language for authoring declarative applications that execute on an ETV-BIF user agent. A TVScript-BIF application consists of an object hierarchy constructed from the various native objects defined by the TVScript-BIF language; optional variables that contain static or dynamic values used during the execution of the application to control application appearance or behavior; optional event function code that is executed in response to events; optional data tables used to control application appearance or behavior; optional resources used when executing the application; and optional signal and trigger data that may be sent to the application during execution. TVScript-BIF applications execute on compliant ETV-BIF user agents. The ETV-BIF binary format and the behavioral requirements for a compliant ETV-BIF user agent are defined by OpenCable specification OC-SP-ETV-BIF1.0-I04-070921 “Enhanced TV Binary Interchange Format 1.0” issued by Cable Television Laboratories Inc., Louisville, Colo., incorporated herein by reference.

The source code of a TVScript-BIF application comprises a series of human-readable files that define the hierarchy of object instances that make up the application; declare the associated functions and variables used during the execution of the application; specify the values of data tables incorporated into the application; designate the source files for image and font resources used by the application; specify the timing and content of signals and triggers sent to the user agent during the execution of the application; and define the structure of the ETV-BIF resources to be generated when compiling the application.

An exemplary in-memory representation of a TVScript-BIF application consists of a series of data structures constructed when the source code for the application is parsed. The data structures comprising the in-memory representation correspond to the various elements comprising the application. Every object instance in a TVScript-BIF application has a matching structure; the contents of the structure reflect the object instance property values specified in the source code. For example, the TVScript-BIF Page object is the parent of all visible and functional objects active at any one time in a TVScript-BIF application. An application may have multiple Page objects, which can become active in sequence. Every Page object is contained within a Partition object, which can have one or more Page object children. A Page object has properties that define, for example, the width and height of the page, the style used to display the page background, flags indicating whether the page is visible, enabled, and selected when the page is first displayed, function code executed when particular events occur during execution (event handler code), and so forth. Some properties must be specified in the TVScript-BIF source code, while other properties have default values and need not be specified in the source code. Another of the properties of a Page object is a list of the child objects of the Page object, defined by the object hierarchy specified by the source code. All of these elements of the application are reflected in the in-memory representation of the application.

By convention, the source code for a given Page object is contained in a single TVScript-BIF source file. When an in-memory representation of an application is being created, the source file is parsed and object structures are created in memory to reflect the object structure of the source file. Each object is represented by an object structure that contains pointers to the string containing the name of the object, values or pointers to values for the properties of the object, a pointer to a list of function strings, and a pointer to a list of child object structures. For convenience, each object also has a pointer to its parent object.

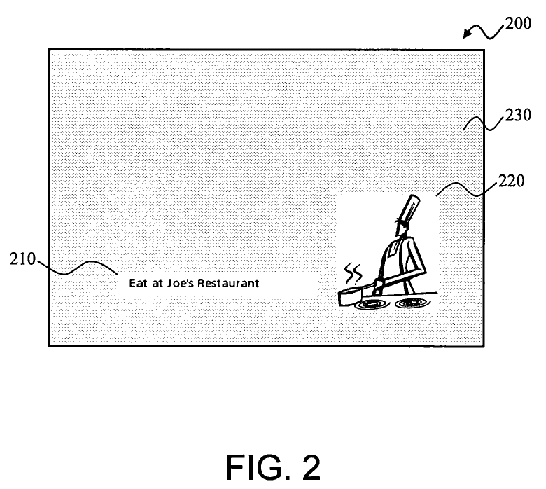

FIG. 2 depicts the appearance of a simple iTV application written in TVScript-BIF. The application display 200 consists of a region of text 210 and an image 220. The graphical background 230 may be filled with a solid or semi-transparent color, or may be transparent to allow the underlying video to display. When the application is deployed to a broadcast environment, the application page resource module is incorporated into the broadcast data stream of a television service. When a user agent recognizes the presence of the application, the user agent reads the module, commences execution of the application and displays the content depicted in FIG. 2, overlaying the graphical content onto the video content of the service. After a fixed period of time, the user agent terminates the application and clears the graphical display.

An author may wish to modify the appearance of the example application, for example by modifying the position, size, shape, or color of the region of color displayed behind the slogan; the position, background color, font face, font size, font weight, text color, alignment, or textual content of slogan text; or the position, size, or image content of the image icon.

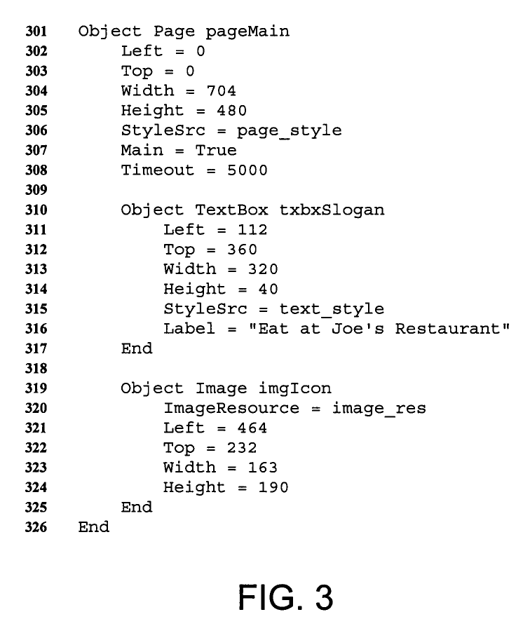

FIG. 3 shows a portion of the TVScript-BIF source code for the application depicted in FIG. 2, specifically the code defining the Page object and its child objects. The numbers depicted at the left of each line are not part of the source code but are provided for reference in the discussion that follows. The Page object definition starts at line 301 and ends at line 326. The type of the object and the name of the object instance are specified at line 301. Lines 302 through 308 define values for specific properties of the Page object instance. All properties not specifically defined in the source code are given their default values when the ETV-BIF resource modules are generated from the application source code. The Page object contains two child objects, a TextBox object defined in lines 310 to 317, and an Image object defined in lines 319 to 325. Note that the source code in FIG. 3 does not define any event handlers. The behavior of the application arises from built-in behavior of the Page widget. The value of the Timeout property specified in line 308 will cause the user agent to generate an OnPageTimeout event if 5000 milliseconds pass with no user activity (in this case, no presses of remote control keys). The default behavior for the OnPageTimeout event is to terminate the application, and this behavior will happen automatically when the OnPageTimeout event is generated.

Attention is directed to lines 306 and 315 in FIG. 3. Each of these lines defines the style associated with the associated object instance. Styles are designated by logical names. A style is an aggregation of data that define aspects of object appearance such as the background, fill, text, and border colors for the object; border style, width and corner radius; font face, size, and weight; text alignment; and so forth. Styles are defined in a separate source file, which is parsed along with the page source file to create an in-memory representation of the styles used by the application.

Attention is further directed to line 320 in FIG. 3. This line defines the resource to be displayed in the Image object. Resources are designated by logical names, in this case “image_res.” The association of the logical name with a URI from which the actual image content is obtained is made in a separate source file, which is parsed along with the page source file to create an in-memory representation of the resources used by the application.

Other source code for the application, not shown in FIG. 3, defines the Page object to be the child of a Partition object, and defines the palette resource that defines the colors used by Page and other child objects within the Partition.

The syntax of TVScript-BIF and the nature of the built-in objects, properties, resources, styles, and so forth lead to natural in-memory object representations of the elements of the application that parallel the syntactic structure of the source code. The inventive method involves conversion between this in-memory representation and an equivalent database representation. Preferentially, the inventive system utilizes a limited set of database structures to represent the application.

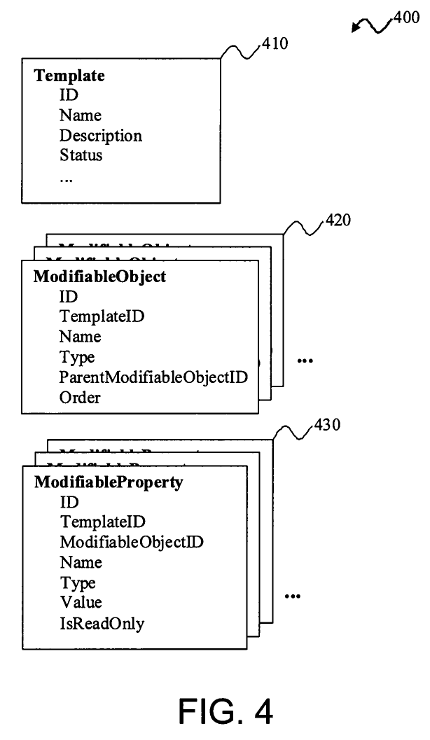

FIG. 4 shows a schematic depiction 400 of a portion of an exemplary set of database structures used to store an in-memory representation of the application shown in FIG. 2 in an object database. Each of the structure types 410, 420, 430, as well as other structure types described below, is stored in a separate table in the database. A field of a given structure may make reference to a structure of a different type in another table, thereby encoding the relationships among the structures that constitute the representation of the application. A top-level template structure 410, in common with all of the database structures, has a identifier (ID) field, the non-zero value of which distinguishes a specific instance of the structure from all other similar structure instances in the same table. Template structure 410 also contains fields that denote the name of the template, provide a description of the template, and contain the current status of the template. Other fields not shown may contain the values for other attributes of the application and template representation, such as an application identifier or owner ID.

Other aspects of an application are represented in the database by ModifiableObject 420 and ModifiableProperty 430 structures. As described above, a TVScript-BIF application comprises a hierarchy of TVScript-BIF objects; each object is represented by a ModifiableObject structure 420. A ModifiableObject structure includes an ID field, and a field that identifies the Template structure to which the ModifiableObject belongs. A ModifiableObject structure has a Name field that gives the name of the corresponding TVScript-BIF object instance, and a Type field that gives the type of the object instance (that is, Page, TextBox, etc.). A ModifiableObject structure has a ParentModifiableObjectID field that names the parent of the object, and an Order field that gives the position of a child object within the list of children of the parent object. By convention, an instance of the top-level Application object has a ParentModifiableObjectID field value of 0, since an Application object is the root of the application representation and has no parent object.

Each object in an application may have a set of associated property values. Each property value is represented by a ModifiableProperty structure 430. A ModifiableProperty structure has an ID field, a TemplateID field that names the template containing the property, and a ModifiableObjectID field that names the object within the template whose property value is defined by the ModifiableProperty structure. A ModifiableProperty structure also contains a Name field that names the property, a Type field that names the type of the property value, and a Value field that contains the value for the property. The Type field value determines the nature of restrictions that can be placed on a replacement value for the Value field. Certain properties, for example the Main property of a Page object, cannot be modified in an application template under any circumstances. A ModifiableProperty structure contains an IsReadOnly field to signal these special cases.

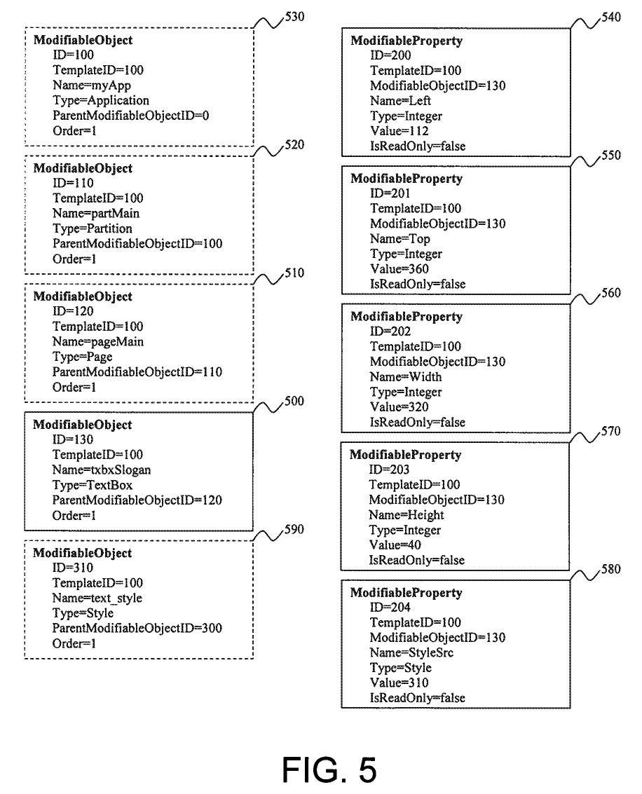

FIG. 5 shows a portion of an exemplary database representation of the TVScript-BIF application shown in FIG. 2. In particular, FIG. 5 shows structures created to represent the txbxSlogan object, the source code for which is shown in FIG. 3, lines 310 to 317. The ModifiableObject structures shown on the left are stored in one table in the database, and the ModifiableProperty structures shown on the right are stored in another table in the database. The ModifiableObject structures with dashed borders are included to depict other structures that are not generated to directly represent the txbxSlogan object, but are referenced by the structures generated to represent the txbxSlogan object.

ModifiableObject structure 500 is the structure corresponding to the txbxSlogan object. The structure has an ID of 130. The TemplateID value of 100 matches the TemplateID value of all the structures generated for this application. The structure Name and Type fields signal the name and type of the object, while the ParentModifiableObjectID field value of 120 signals that ModifiableObject structure 510 (which has an ID of 120) is the parent object of this object. ModifiableObject structure 510 in turn corresponds to the Page object, and has a ParentModifiableObjectID field value of 110, signaling that ModifiableObject structure 520 is the parent object of the Page object. ModifiableObject structure 520 corresponds to a Partition object, and has a ParentModifiableObjectID field value of 100, signaling that ModifiableObject structure 530 is the parent object of the Partition object. ModifiableObject structure 530 is of type Application, which is the parent object of the entire application. An Application object has a ParentModifiableObjectID field of 0, signaling that it is the root object of the object tree.

The properties of the txbxSlogan object are represented by ModifiableProperty structures 540, 550, 560, 570, 580. ModifiableProperty structure 540 has an ID of 200 and a ModifiableObjectID field value of 130, which identifies ModifiableProperty structure 500 as the corresponding object to which the property value applies. ModifiableProperty structure 540 has a Name field value of Left, a Type field value of Integer, and a Value field value of 112, corresponding to the contents of source code line 311 from FIG. 3. Other ModifiableProperty structures 550, 560, 570, and 580 correspond to the other specified property values from the source code from source code lines 312, 313, 314, and 315 respectively. ModifiableProperty structure 580 in particular has a Name field value of StyleSrc and a Type field value of Style, signaling that this property refers to a Style structure. The Value field value of 310 signals the ID of the corresponding ModifiableObject structure 590 that represents the corresponding Style structure.

The TVScript Partition object corresponds to the ETV-BIF page resource and serves as the parent object of all Page objects contained in the Partition object. The TVScript-BIF ResourceArchive object, which corresponds to the ETV-BIF data resource module, can be the parent object of data tables.

Each TVScript-BIF Partition object has an associated StyleSheet object, the representation of which is stored in a stylesheet source code file. A StyleSheet object is the parent of all the Styles defined in the stylesheet file. Styles are represented by ModifiableObject and ModifiableProperty structures. A TVScript-BIF style comprises a Style structure that references a sequence of nested StyleElement structures, reflecting the ETV-BIF style organization model. In source code, a Style structure contains a set of optional attributes, which refer to StyleElements that define the corresponding sub-styles. Similarly, a StyleElement structure contains a set of optional attributes, which may specify values directly or may refer to further StyleElements. In the database representation of a template, a style is represented by a ModifiableObject structure of type “Style”, the properties of which point to sub-style ModifiableObject structures, corresponding to the Alignment, Background, Fill, . . . sub-structures of the ETV-BIF Style structure. Each sub-style ModifiableObject structure has the appropriate type, and associated ModifiableProperty structures representing the values in the sub-style may contain literal values or may point to further ModifiableObject structures. A Style structure may be incomplete in the source code file, that is, some of the optional attributes may be unspecified. This signals that any TVScript-BIF object that references the incomplete Style inherits the unspecified portions of the Style structure from its parent object.

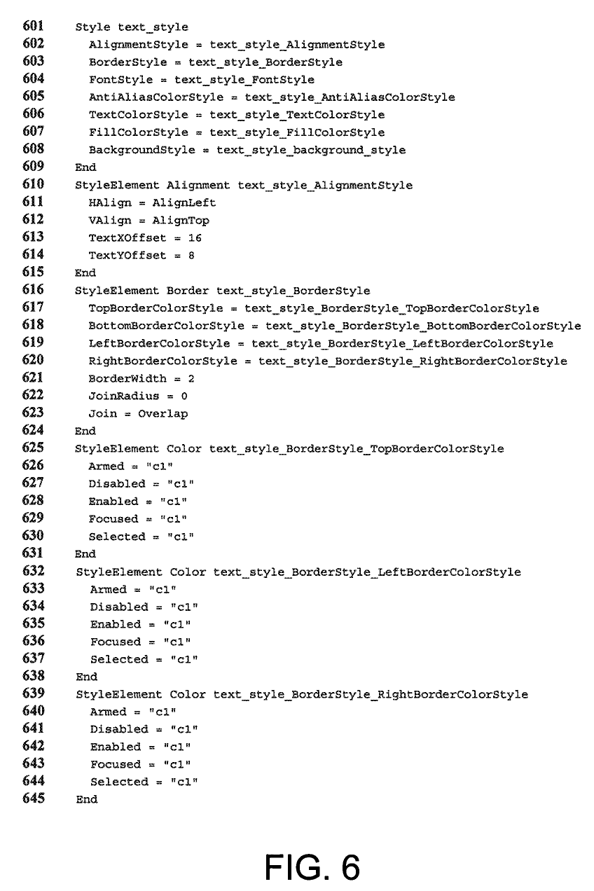

FIG. 6 shows a fragment of a stylesheet source code file. The numbers depicted at the left of each line are not part of the source code but are provided for reference in the discussion that follows. The “text_style” Style is defined by lines 601 to 609. Each of the properties of the Style object refers to a sub-style object. For example, line 602 declares that the Alignment sub-style for the “text_style” Style is defined by a StyleElement of type Alignment named “text_style_AlignmentStyle”. This sub-style is defined in turn by lines 610 to 615. Similarly, line 603 declares that the Border sub-style for the “text_style” Style is defined by a StyleElement of type Border named “text_style_BorderStyle”. The corresponding declaration of “text_style_BorderStyle” is found in lines 616 to 624. The declaration of a StyleElement of type Border includes four properties that refer to further sub-styles (lines 617, 618, 619, 620) and three properties that have direct values (lines 621, 622, 623). Property line 617, for example, declares that the color style for the top portion of the border is defined by a StyleElement of type Color named “text_style_BorderStyle_TopBorderColorStyle”. The corresponding StyleElement declaration is found in lines 625 to 631. The color names used in lines 625 to 631 are defined in a separate palette source code file (not shown). Additional Color StyleElements are defined by lines 632 to 638 and lines 639 to 645. Additional Styles and StyleElements are defined in further source code lines (not shown).

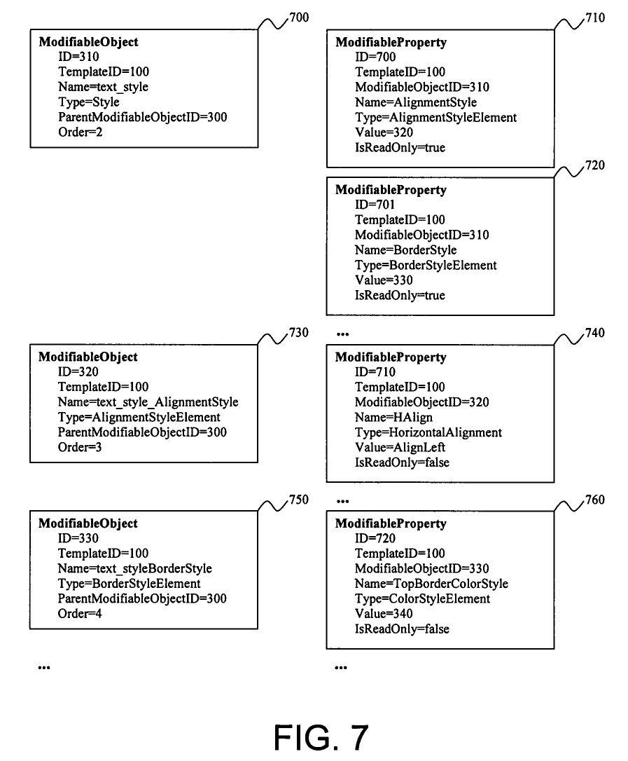

FIG. 7 depicts a portion of an exemplary set of database structures generated to represent the Style source code fragment depicted in FIG. 6. ModifiableObject structure 700 represents the Style object defined by source code lines 601 to 609. ModifiableProperty structure 710 represents the Alignment property of the “text_style” Style object defined in source code line 602. Note that the IsReadOnly field of this ModifiableProperty structure has a Value field value of “true”, since the style/sub-style hierarchy cannot be modified in a template. ModifiableProperty structure 710 references ModifiableObject structure 730. ModifiableProperty structure 720 represents the Border property of the “text_style” Style object defined in source code line 603. ModifiableProperty structure 720 references ModifiableObject structure 750. Other ModifiableProperty structures (not shown) represent the other properties of the “text_style” Style object. ModifiableObject structure 730 represents the “text_style_AlignmentStyle” Alignment sub-style defined by source code lines 610 to 615. ModifiableProperty structure 740 represents the “HAlign” property value of the Alignment sub-style defined in source code line 611. Other ModifiableProperty structures (not shown) represent the other properties of the Alignment sub-style. ModifiableObject structure 750 represents the “text_style_BorderStyle” Border sub-style defined in source code lines 616 to 624. ModifiableProperty structure 760 represents the “TopBorderColorStyle” property of the Border sub-style. ModifiableProperty 760 references a further ModifiableObject structure (not shown), which represents the Color sub-style defined in source code lines 625 to 631. Other ModifiableProperty structures (not shown) represent the other properties of the Border sub-style. If a Style or StyleElement is incomplete, only those properties that are specified have corresponding ModifiableProperty structures. ModifiableObject structures 700, 730, and 750 have ParentModifiableObjectId field values of 300, referencing a ModifiableObject structure of type StyleSheet (not shown).

Table resources are represented in the database by ModifiableObject structures. A table resource can be contained within a Partition or a ResourceArchive object. The ModifiableObject structure corresponding to a table resource has a ParentModifiableObject value that identifies the ModifiableObject structure corresponding to the Partition or ResourceArchive object that contains the table resource.

Table resources in a TVScript-BIF application correspond to data tables in the ETV-BIF binary output. A Table resource has a corresponding data table definition in the TVScript-BIF source code for the resource. A data table is represented in the database by a series of structures. A parent ModifiableObject structure represents the table resource, with a Type field value of “Table”. This parent ModifiableObject structure has one or more child ModifiableObject structures representing the columns of the table. The parent structure also has one or more child ModifiableObject structures representing the rows, which in turn have one or more child ModifiableObject structures representing the cells, the values of which are represented by ModifiableProperty structures. The filename of the data file is stored in a ModifiableProperty structure that refers to the ModifiableObject structure for the resource. Palettes are a special case of a data table, in which the Type field of the ModifiableObject structure for the palette has a value of “Palette”.

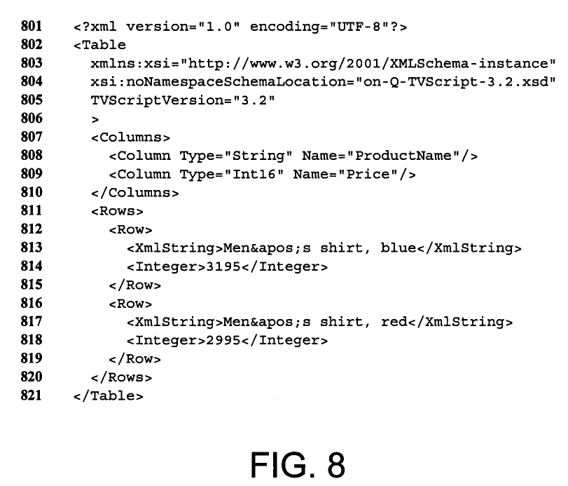

FIG. 8 shows example TVScript-BIF source code for a Table resource. The numbers depicted at the left of each line are not part of the source code but are provided for reference in the discussion that follows. The example data table has two rows; each row has two columns, the first a string naming a product and the second an integer giving the purchase price in cents. By convention, the structure and content of the resource are specified in XML format. Source code line 801 signals this fact, and specifies that the content is encoded in UTF-8 format. Source lines 802 to 806 declare the outer-most Table tag, provide the namespace and default schemas for the content, and provide a TVScript version reference. The types and names of the columns are defined by the tags in lines 807 to 810. The contents of the table rows are defined by the tags in lines 811 to 820.

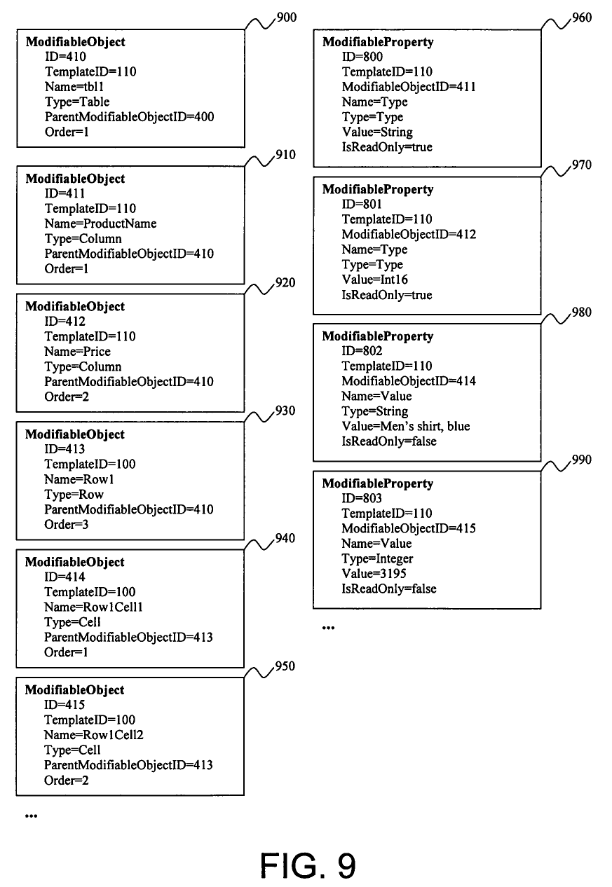

FIG. 9 depicts a portion of a set of exemplary database structures that represent the Table resource depicted in FIG. 8. ModifiableObject structure 900 is the parent object that represents the data table content. ModifiableObject structures 910, 920 represent the columns of the data table, each specifying the name of the corresponding column. ModifiableObject structure 930 represents the first row of the data table. ModifiableObject structure 930 has two child structures 940, 950 that represent the cells of the first row of the data table. Other ModifiableObject structures not shown represent the second row and its cells. ModifiableProperty structure 960 defines the data type of the first column of the table, while ModifiableProperty structure 970 defines the data type of the second column of the table. Both of the ModifiableProperty structures 960, 970 have an IsReadOnly value of “true”, signaling that the schema for the data table cannot be modified in the template. ModifiableProperty structure 980 represents the value of the cell in the first row, first column of the table. The content of the Value field is “Men's shirt, blue”. Note that the corresponding content of the XML file contains an XML escape sequence for the apostrophe character in the string, which is decoded when the XML file content is read into memory and stored into the database, but which must be re-encoded if the string content is streamed back out into XML format. ModifiableProperty structure 990 represents the value of the cell in the first row, second column of the table. The content of the Value is “3195”. Other ModifiableProperty structures not shown represent the values of the cells in the second row.

Other resources defined in the application source code are also represented by ModifiableObject structures. For example, an Image resource is represented by a ModifiableObject structure that has a Name field that contains the logical name of the resource and a Type field value of “Image”. The URI that specifies the source for the resource is represented by a ModifiableProperty structure that references the ModifiableObject structure for the resource, has a Name field value of “Source”, and has a Type field value of “URI”. The Value field value of the ModifiableProperty structure is the URI for the image resource.

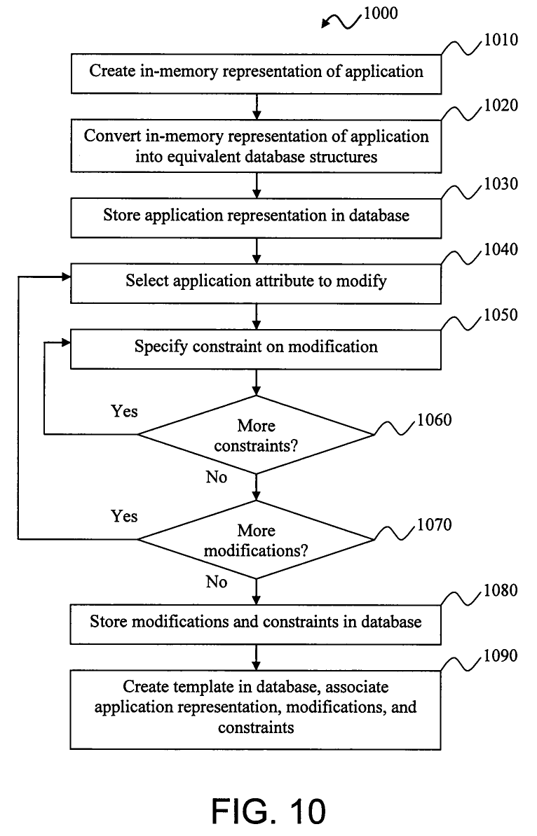

FIG. 10 depicts a flowchart 1000 of the steps performed during an exemplary implementation of the template creation process. At a step 1010 an in-memory representation is made of the original application. As described above, the original application may be provided in source code or in executable form. At a further step 1020 the in-memory representation is converted into an equivalent set of database structures as described above. At a further step 1030 the application representation database structures are stored in a database. At a further step 1040 an attribute of the application is selected to modify. Considering the application depicted in FIG. 2, examples of attributes that might be modified include the position, size, shape or color of the region containing the text displayed by the application. Other examples of attributes that might be modified include the position, font face, font size, font weight, text color, alignment, or textual content of the text displayed by the application. Still other examples of attributes that might be modified include the position, size, or image content of the image displayed by the application. In general, any attribute represented by a ModifiableProperty structure that does not have an IsReadOnly field value of “true” is subject to modification; however, other considerations might limit the range of properties that are desired to be modified in the application.

In an alternative embodiment of the inventive system, addition information related to the modification may be specified at this step. In an alternative embodiment, a label for the attribute being modified might be specified, with the label being presented when the modification is available for selection. In an alternative embodiment, a rule might be specified as to whether the annotation is required or optional. In an alternative embodiment, a hint might be specified to display to the editor when the modification is being performed.

Once an attribute is selected to modify, at a further step 1050 a constraint is specified on the modification. At least one implicit constraint is specified for each modification, namely that the replacement value be of the same type as the original value in the ModifiableProperty structure. Additional constraints may be applied that depend on the type of the value. For example, if the value of the attribute to be modified is a string, the constraint might be a limit on the number of characters in the replacement string. As further examples, if the attribute to be modified is a string, the constraint might be that the replacement string is one of a list of possible strings, or that the replacement string matches a regular expression. If the value of the attribute to be modified is an integer, the constraint might be that the replacement value fall within a given range. A value range might be bounded (have both lower and upper bounds) or half-bounded (have either a lower or an upper bound but not both). A constraint might be specified as a combination of other constraints; that is, a constraint might be that the replacement value satisfies all of a given set of constraints, or alternatively a constraint might be that the replacement value satisfies any one of a given set of constraints.

After a constraint is specified, at a further step 1060 a decision is made whether there are more constraints for the modification of the selected application attribute. If so, step 1050 is repeated. If not, at a further step 1070 a decision is made whether there are more application attributes to be modified. If so, step 1040 is repeated. If not, at a further step 1080 the modifications and constraints are stored in a database. At a further step 1090, a template structure is created in a database, and the structures representing the application, the modifications, and the constraints are associated with the template structure.

The steps of flow chart 1000 may be performed by a single user or by multiple users working consecutively or concurrently.

In an exemplary implementation of the inventive system, a modification is stored in the database in a ModificationAction structure. A ModificationAction structure contains an ID field that denotes the unique identifier for this ModificationAction structure among all ModificationAction structures. A ModificationAction structure also contains a TemplateID field that denotes the Template to which the modification is associated; a ModifiableObjectID field that denotes the identifier of the ModifiableObject structure associated with the attribute being modified; and a ModifiablePropertyID field that denotes the identifier of the ModifiableProperty structure whose value is to be modified. In an alternative exemplary embodiment, the ModificationAction structure contains a Status field that denotes the status of the modification, the value of which might be one of “pending”, “completed”, or “reviewed”. The interpretation of the Status field value is that “pending” signifies that the modification has not been performed; “completed” signifies that the modification has been performed but not reviewed; and “reviewed” signifies that the modification has been performed and reviewed. In this alternative embodiment, the editing of an application template copy is not completed until all ModificationAction structures have a Status field value of “reviewed”. In a further alternative exemplary embodiment of the inventive system, a ModificationAction structure might have an additional Rule field that denotes a rule for the modification, the value of which will be one of “required”, “optional”, or “forbidden”, where a value of “required” signifies that the modification must be performed when modifying the template to create a new application, “optional” signifies that the modification may be performed when modifying the template, and “forbidden” signifies that in this copy of the template, the modification has been disallowed. In a further alternative exemplary embodiment of the inventive system, a ModificationAction structure might have a Sequence field that denotes the sequential order in which the modifications will be presented during the template editing process.

In an exemplary implementation of the inventive system, a constraint is stored in the database using one or more ModificationConstraint structures. A ModificationConstraint structure contains an ID field that denotes the unique identifier for this ModificationConstraint structure among all ModificationConstraint structures. A ModificationConstraint structure also contains a TemplateID field that denotes the Template to which the modification constraint is associated; a ModificationActionID field that denotes the identifier of the ModificationAction structure associated with the constraint; a ModificationConstraintID field that optionally denotes the identifier of a ModificationConstraint structure associated with the constraint; a Type field that denotes the type of the constraint, and a Value field that denotes the value associated with the constraint type. A simple constraint may apply directly to a modification action. For example, if the maximum number of characters allowed in a string is 6, the constraint is encoded with a Type field value of “maximum length” and a Value field value of “6”. A more complex constraint may involve one or more subordinate ModificationConstraint structures. For example, a constraint that specifies the valid range of an integer modification value would be encoded by a first ModificationConstraint structure with a Type field value of “range” and an empty Value field; a second ModificationConstraint structure with a ModificationConstraintID field value that references the first ModificationConstraint structure, a Type field value of “minimum”, and a Value field value listing the minimum end of the range; and a third ModificationConstraint structure with a ModificationConstraintID field value that references the first ModificationConstraint structure, a Type field value of “maximum”, and a Value field value listing the maximum end of the range. Additional constraint types include for example type “match” which signals that a modification value matching the Value field is acceptable; type “file extension” that signals that any file with the corresponding extension type given by the Value field is acceptable; type “regular expression” that signals that any string matching the regular expression given by the Value is acceptable; logical negation type “not” that signals that for the ModificationConstraint to be met, the ModificationConstraint structure that references the negation ModificationConstraint must not be met; and logical combination types “and” and “or” which signal a conjunction or disjunction, respectively, among the ModificationConstraint structures that reference the logical combination ModificationConstraint. Thus, for example, if a constraint requires that a modification value can be one of a list of three possible values, the constraint could be encoded with a logical combination type “or” ModificationConstraint structure and three type “match” ModificationConstraint structures that reference the logical combination type “or” ModificationConstraint structure.

The steps described above in reference to FIG. 10 are performed through the use of the template creation component 140 described above in reference to FIG. 1.

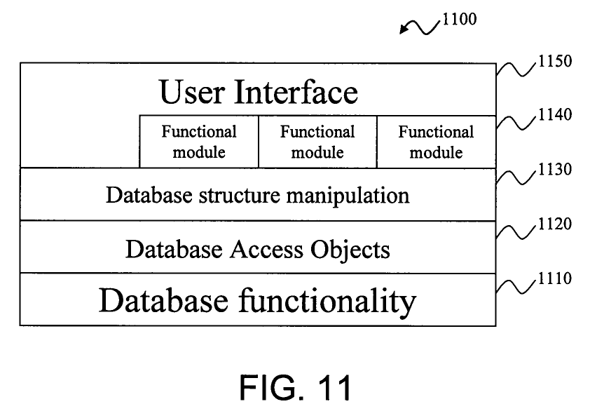

FIG. 11 depicts a schematic view of a software layer model 1100 of the organization of an exemplary implementation of the functionality of template creation component 140 and an associated database 150. The base layer of the software layer model is the database functionality 1110. This layer provides for storage and manipulation of structures within a physical storage system, and corresponds to a conventional database “engine”. Above the base layer is a data access objects layer 1120 that serves to isolate the physical processes of the database from higher layers, and to abstract the internal functionality of database functionality layer 1110. The communication between data access object layer 1120 and database functionality layer 1110 is by any conventional protocol such as Software Query Language (SQL). Data access objects layer 1120 translates between external structure representations as depicted for example in FIG. 4 and the internal representations of these structures within the database engine.

Database structure manipulation layer 1130 provides for basic manipulations of the structures stored in the database. For example, this layer provides application programming interface (API) functions to create, modify, copy, and delete database structures and sets of structures. This API is used by functional modules 1140 to perform operations that are specific to the task being performed. For example, a functional module might perform the operation of reading in application source code and creating an in-memory representation, then converting the in-memory representation to an equivalent set of database structures. The activity of functional modules 1140 is controlled through a further API that can be accessed by user interface layer 1150, which also utilizes the API provided by database structure manipulation layer 1130. User interface functionality may be provided by software specifically coded for this purpose, by a web browser interacting with a web services interface, or by other means well known in the art.

The divisions depicted in FIG. 11 are not intended to be limiting. One skilled in the art will recognize that the features and functionality of a layer might be subdivided and combined in other ways. Furthermore, the functionality of a single layer or multiple layers might be performed on a single computer, or on multiple computers. The functionality of one or more layers might be provided by a server shared by multiple computers, or by multiple servers. Different layers may be implemented using different software environments, such as C#/.NET, C++, Java, or other similar languages. When different layers are provided on different computers, the communication between the computers may be through a common protocol such as HyperText Transfer Protocol (HTTP), Simple Object Access Protocol (SOAP), Common Object Request Broker Architecture (CORBA), Distributed Common Object Model (DCOM), JavaScript Object Notation (JSON), or through another standardized or proprietary interface protocol.

Once a template is created, an updated version of the original application can be created.

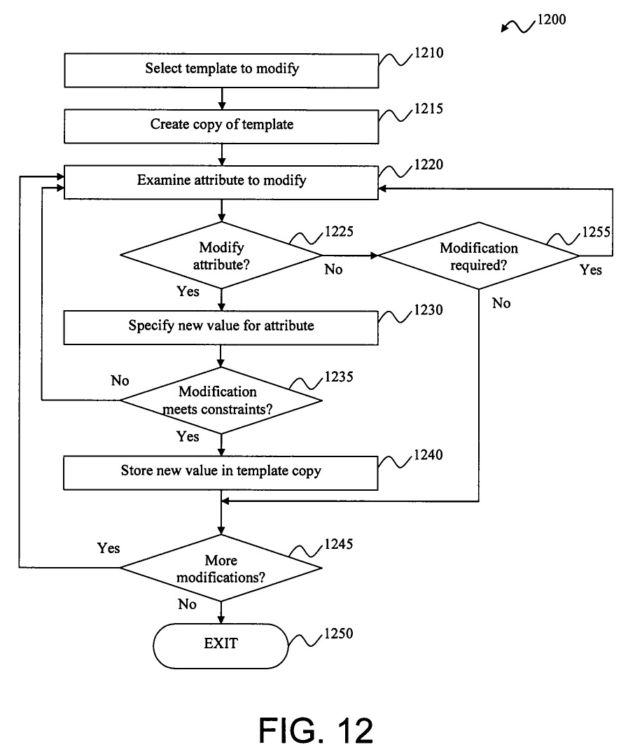

FIG. 12 depicts a flowchart 1200 of the steps performed during an exemplary implementation of the template editing process. At a step 1210 an application template in a database is selected for which a new version of the application is desired. At a further step 1215 a copy of the application template is created in the database. At a further step 1220 an attribute to be modified is examined. At a further step 1225 a decision is made whether to modify the attribute. If the decision is made to modify the attribute, at a further step 1230 the new value for the attribute is specified. At a further step 1235, a check is made to determine if the new value for the attribute satisfies the constraints for the modification. If the new value does not satisfy the constraints, step 1220 is repeated. If the new value does satisfy the constraints, at a further step 1240 the new value is stored in the template copy in the database. At a further step 1245, a check is made to determine if more modifications remain to be examined. If so, the next sequential modification is selected and step 1220 is repeated. If no more modifications remain to be examined, the process terminates at a step 1250. If when the check was performed at a step 1225 the decision was to not modify the attribute, then at a further step 1255 a check is made to determine whether the modification is required. If the modification is required, step 1220 is repeated. If the modification is not required, step 1245 is performed to determine if more modifications remain to be examined

The steps of flow chart 1200 may be performed by a single user or by multiple users working consecutively or concurrently.

Once all modifications have been performed on a template copy, a review step might be performed to verify that all modifications meet an external set of criteria not embodied within the constraints in the template.

The operations described above in reference to FIG. 12 are performed using template editing component 170 described above in reference to FIG. 1. In an exemplary implementation of the inventive system, the organization of the functionality of template editing component 170 also follows the software layer model 1100 depicted in FIG. 11 and described above. In an exemplary implementation of template editing component 170, a functional module 1140 performs constraint validation operations required to verify that a supplied value for a modification satisfies the constraints. The functionality and implementation of the layers of software layer model 1100 utilized by template editing component 170 may be unique to the template editing component, or may be shared with template creation component 140.

Once all modifications are made to a copy of an application template, application generation component 180 is used to create an executable version of the modified application. The modified copy of the application template is retrieved from a database and used to create an in-memory representation of the application. The in-memory representation is used to generate the executable version of the application. The generation process may proceed by using the in-memory representation to create one or more source code files that reflect the content of the application template, and then use an external compiler tool to generation an executable version of the application from the source code. Alternatively, the in-memory representation may used to directly generate an executable version of the application.

In an exemplary implementation of the inventive system, the organization of the functionality of application generation component 180 also follows the software layer model 1100 depicted in FIG. 11 and described above. In an exemplary implementation of application generation component 180, functional modules 1140 perform the required manipulations of the modified application template to generate the application executable. The functionality and implementation of the layers of software model 1100 utilized by the application generation component 180 may be unique to the application generation component, or may be shared with template creation component 140 and template editing component 170.

The term “computer” is used herein to refer to any device with processing capability such that it can execute instructions. Those skilled in the art will realize that such processing capabilities are incorporated into many different devices and therefore the term “computer” includes PCs, servers, mobile telephone, personal digital assistants and many other devices.

The methods described herein may be performed by software in machine readable form on a storage medium. The software can be suitable for execution on a parallel processor or a serial processor such that the method steps may be carried out in any suitable order, or simultaneously.

The description acknowledges that software can be a valuable, separately tradable commodity. The description is intended to encompass software, which runs on or controls ‘dumb’ or standard hardware, to carry out the desired functions. It is also intended to encompass software which ‘describes’ or defines the configuration of hardware, such as HDL (hardware description language) software, as is used for designing silicon chips, or for configuring universal programmable chips, to carry out desired functions.

The steps of the methods described herein may be carried out in any suitable order, or simultaneously where appropriate. Aspects of any of the examples described above may be combined with aspects of any of the other examples described to form further examples without losing the effect sought.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. In a computer system providing an application authoring environment utilizing an object database, a method of creating a modified version of an application characterized by:
creating an application template from said application in said object database;
making a copy of said application template in said database;
modifying said copy of said application template in said database; and
generating an executable application from said modified copy.

2. The method of claim 1, wherein the creation of said application template is characterized by:
creating in memory an object representation of said application;
storing said object representation in said object database; and
converting said object representation into an application template.

3. The method of claim 2, wherein the conversion of said object representation into an application template is characterized by:
selecting at least one attribute of said object representation that is suitable for modification;
creating at least one metadata item that specifies the at least one attribute suitable for modification and specifies at least one requirement for the modification of said attribute;
aggregating each of said at least one metadata item;
associating said aggregated metadata with said object representation; and
storing said metadata with said object representation in said object database.

4. The method of claim 3, wherein the modification of said copy of said application template is characterized by:
selecting at least one metadata item associated with said copy of said object representation; and
modifying at least one attribute of said object representation specified in said metadata item in accordance with each of the at least one requirement for the modification of said attribute.

5. The method of claim 2, wherein generating an executable application is characterized by:
extracting said modified copy of said object representation to create a modified object representation in memory; and
generating an executable application from said modified object representation.

6. The method of claim 5, wherein the generation of an executable application is performed by generating a set of at least one human-readable source code file from said modified object representation and compiling said set of source code to produce an executable application.

7. The method of claim 5, wherein the generation of an executable application is performed directly from said modified object representation.

8. The method of claim 2, wherein the object representation in memory is created by parsing the source code of said application.

9. The method of claim 2, wherein the object representation in memory is created by decompiling the executable version of said application

10. The method of claim 1, wherein database operations are performed using a web services interface.

11. A computer system for creating a modified version of an application comprising:
an object database;
a template creation component configured to create an application template from said application in said object database;
a template editing component configured to modify a copy of said application template in said object database; and
an application generation component configured to generate an executable application from said modified copy of said application template.

12. The system of claim 11, wherein said template creation component is further configured to:
create in memory an object representation of said application;
store said object representation in said object database; and
convert said object representation into an application template.

13. The system of claim 12, wherein said template creation component is further configured to convert said object representation into an application template by:
selecting at least one attribute of said object representation that is suitable for modification;
creating at least one metadata item that specifies the at least one attribute suitable for modification and specifies at least one requirement for the modification of said attribute;
aggregating each of said at least one metadata item;
associating said aggregated metadata with said object representation; and
storing said metadata with said object representation in said object database.

14. The system of claim 13, wherein said template editing component is configured to modify said copy of said application template by:
selecting at least one metadata item associated with said copy of said object representation; and
modifying at least one attribute of said object representation specified in said metadata item in accordance with each of the at least one requirement for the modification of said attribute.

15. The system of claim 12, wherein said application generation component is further configured to:
extract said modified copy of said object representation from said object database to create a modified object representation in memory, and
generate an executable application from said modified object representation.

16. The system of claim 15, wherein said application generation component is further configured to generate an executable application from said modified object representation by:
generating a set of at least one human-readable source code file; and
compiling said set of source code to produce an executable application.

17. The system of claim 15, wherein said application generation component is further configured to generate an executable application directly from said modified object representation.

18. The system of claim 12, wherein said template creation component is further configured to create the object representation in memory by parsing the source code of said application.

19. The system of claim 12, wherein said template creation component is further configured to create the object representation in memory by decompiling the executable version of said application

20. The system of claim 11, wherein said object database is configured to utilize a web services interface.
